(19) United States
(12) Patent Application Publication
(10) Pub. No.: US 2023/0275681 A1
(43) Pub. Date: Aug. 31, 2023

(54) SIGNAL SENDING METHOD, SIGNAL RECEIVING METHOD, AND APPARATUS

(71) Applicant: HUAWEI TECHNOLOGIES CO., LTD., Shenzhen (CN)

(72) Inventors: Mengting LIU, Beijing (CN); Xin GAO, Beijing (CN); Jianghua LIU, Beijing (CN)

(21) Appl. No.: 18/314,960

(22) Filed: May 10, 2023

Related U.S. Application Data
(63) Continuation of application No. PCT/CN2020/128220, filed on Nov. 11, 2020.

(51) Int. Cl. H04J 13/18; H04L 5/00

(52) U.S. Cl. CPC H04J 13/18; H04L 5/0048

(57) ABSTRACT

A signal sending method includes generating a first signal based on a reference sequence or an orthogonal cover code (OCC), where the reference sequence is a sequence in a sequence set; and any two sequences in the sequence set are orthogonal to each other; or the OCC is included in an OCC set, and any two OCCs in the OCC set are orthogonal to each other; and sending the first signal on M time-frequency resource elements, where the first signal includes M sub-signals; the M time-frequency resource elements are in a one-to-one correspondence with the M sub-signals; any two of the M time-frequency resource elements do not overlap in frequency domain or in time domain; and M is an integer greater than 1.

### CROSS-REFERENCE TO RELATED APPLICATIONS

This application is a continuation of International Application No. PCT/CN2020/128220, filed on Nov. 11, 2020, the disclosure of which is hereby incorporated in entirety by reference.

### BACKGROUND

In a new radio (NR) system, a base station performs positioning or channel measurement by measuring an uplink sounding reference signal (SRS) sent by a terminal device. An SRS used for positioning is also referred to as a positioning SRS (pos-SRS). Currently, through research, in response to an SRS being used for positioning, positioning precision greatly depends on a bandwidth of the SRS. A higher bandwidth indicates higher positioning precision.

The bandwidth of the SRS is related to a capability of a terminal device. For example, a maximum bandwidth supported by a normal-capability terminal device is 100 MHz, and a maximum bandwidth supported by a reduced-capability terminal device is 20 MHz. Therefore, a problem of how to send a wide bandwidth in response to a bandwidth of an uplink signal being low calls for being resolved.

### SUMMARY

An objective of implementations of some embodiments is to provide a signal sending method, a signal receiving method, and an apparatus, to resolve a problem of how to send a signal with a wide bandwidth in response to a bandwidth of an uplink signal being low.

Some embodiments provide a signal sending method. The method is applicable to a scenario in which a network device positions a terminal device. The method is performed by the terminal device or a module in the terminal device. Herein, an example in which the terminal device executes the method is used for description. The method includes: generating a first signal based on a reference sequence and/or an orthogonal cover code OCC; and sending the first signal on M time-frequency resource elements, where the first signal includes M sub-signals, the M time-frequency resource elements are in a one-to-one correspondence with the M sub-signals, any two of the M time-frequency resource elements do not overlap in frequency domain or in time domain, and M is an integer greater than 1; and the reference sequence is a sequence in a sequence set, and any two sequences in the sequence set are orthogonal to each other; and/or the OCC is an OCC in an OCC set, and any two OCCs in the OCC set are orthogonal to each other.

According to the foregoing method, because first signals generated by different terminal devices based on the reference sequence and/or the orthogonal cover code OCC are orthogonal, in response to the first signals being transmitted on the M time-frequency resource elements, the network device distinguishes between the first signals sent by the different terminal devices on the M time-frequency resource elements, so that a signal with a high bandwidth is sent over a narrow bandwidth, thereby improving resource utilization.

At least some signals carried on the M time-frequency resource elements are orthogonal, so that mutual interference between signals sent on the M time-frequency resource elements are reduced. in response to the first signal being used for positioning, positioning precision is improved.

In some embodiments, the generating a first signal based on a reference sequence includes: generating M sub-signals based on the reference sequence, where the reference sequence includes M sub-sequences, and the M sub-signals are in a one-to-one correspondence with the M sub-sequences.

In some embodiments, each of the M sub-sequences is intercepted from the reference sequence.

In some embodiments, the generating a first signal based on a reference sequence and an OCC includes: generating the M sub-signals based on the reference sequence and the OCC, where the OCC includes M elements, and the M elements are in a one-to-one correspondence with the M sub-signals.

In some embodiments, each of the M sub-signals corresponds to the reference sequence.

In some embodiments, the M sub-signals are generated by extending the reference sequence by using the OCC.

In some embodiments, the M sub-signals are generated by intercepting the reference sequence and extending, by using the OCC, a part obtained through interception.

In some embodiments, the first signal is orthogonal to a second signal carried on N time-frequency resource elements, and frequency domain resources of the M time-frequency resource elements completely or partially overlap frequency domain resources of the N time-frequency resource elements.

In some embodiments, the second signal corresponds to a sequence other than the reference sequence in the sequence set; and/or the second signal corresponds to an OCC other than the OCC in the OCC set.

In some embodiments, the first signal is a positioning reference signal.

Some embodiments provide a signal receiving method. The method is applicable to a scenario in which a network device positions a terminal device. The method is performed by a network device or a module in a network device. Herein, an example in which the network device executes the method is used for description. The method includes: determining M time-frequency resource elements; and obtaining a first signal on the M time-frequency resource elements, where the first signal is generated based on a reference sequence and/or an orthogonal cover code OCC; the first signal includes M sub-signals, the M time-frequency resource elements are in a one-to-one correspondence with the M sub-signals, any two of the M time-frequency resource elements do not overlap in frequency domain or in time domain, and M is an integer greater than 1; and the reference sequence is a sequence in a sequence set, and any two sequences in the sequence set are orthogonal to each other; and/or the OCC is an OCC in an OCC set, and any two OCCs in the OCC set are orthogonal to each other.

According to the foregoing method, because first signals generated by different terminal devices based on the reference sequence and/or the orthogonal cover code OCC are orthogonal, in response to the first signals being transmitted on the M time-frequency resource elements, the network device distinguishes between the first signals sent by the different terminal devices on the M time-frequency resource elements, so that a signal with a high bandwidth is sent over a narrow bandwidth, thereby improving resource utilization.

In some embodiments, the M sub-signals in the first signal are generated based on the reference sequence, the reference sequence includes M sub-sequences, and the M sub-signals are in a one-to-one correspondence with the M sub-sequences.

In some embodiments, each of the M sub-sequences is intercepted from the reference sequence.

In some embodiments, the M sub-signals in the first signal are generated based on the reference sequence and the OCC, the OCC includes M elements, and the M elements are in a one-to-one correspondence with the M sub-signals.

In some embodiments, each of the M sub-signals corresponds to the reference sequence.

In some embodiments, the M sub-signals are generated by extending the reference sequence by using the OCC.

In some embodiments, the M sub-signals are generated by intercepting the reference sequence and extending, by using the OCC, a part obtained through interception.

In some embodiments, the first signal is orthogonal to a second signal carried on N time-frequency resource elements, and frequency domain resources of the M time-frequency resource elements completely or partially overlap frequency domain resources of the N time-frequency resource elements.

In some embodiments, the second signal corresponds to a sequence other than the reference sequence in the sequence set; and/or the second signal corresponds to an OCC other than the OCC in the OCC set.

In some embodiments, the first signal is a positioning reference signal.

Some embodiments provide a communication apparatus. The communication apparatus has a function of implementing any method provided in the embodiments. The communication apparatus is implemented by hardware, or is implemented by hardware executing corresponding software. The hardware or the software includes one or more units or modules corresponding to the foregoing function.

In some embodiments, the communication apparatus includes a processor. The processor is configured to support the communication apparatus in performing a corresponding function of the terminal device in the foregoing method. The communication apparatus further includes a memory. The memory is coupled to the processor, and the memory stores program instructions and data that are for the communication apparatus. Optionally, the communication apparatus further includes a communication interface, and the communication interface is configured to support communication between the communication apparatus and a device such as a network device.

In some embodiments, the communication apparatus includes corresponding functional modules, configured to implement the steps in the foregoing method. The function is implemented by hardware, or is implemented by hardware executing corresponding software. The hardware or the software includes one or more modules corresponding to the foregoing function.

In some embodiments, a structure of the communication apparatus includes a processing unit and a communication unit. These units performs corresponding functions in the foregoing method examples. For details, refer to the descriptions in the method provided in the embodiments. The details are not described herein again.

Some embodiments provide a communication apparatus. The communication apparatus has a function of implementing any method provided in the embodiments. The communication apparatus is implemented by hardware, or is implemented by hardware executing corresponding software. The hardware or the software includes one or more units or modules corresponding to the foregoing function.

In some embodiments, the communication apparatus includes a processor. The processor is configured to support the communication apparatus in performing a corresponding function of the network device in the foregoing method. The communication apparatus further includes a memory. The memory is coupled to the processor, and the memory stores program instructions and data that are for the communication apparatus. Optionally, the communication apparatus further includes a communication interface. The communication interface is configured to support communication between the communication apparatus and a device such as a terminal device.

In some embodiments, the communication apparatus includes corresponding functional modules, configured to implement the steps in the foregoing method. The function is implemented by hardware, or is implemented by hardware executing corresponding software. The hardware or the software includes one or more modules corresponding to the foregoing function.

In some embodiments, a structure of the communication apparatus includes a processing unit and a communication unit. These units performs corresponding functions in the foregoing method examples. For details, refer to the descriptions in the method provided in the embodiments. The details are not described herein again.

In some embodiments, a communication apparatus is provided, and includes a processor and a communication interface. The communication interface is configured to: receive a signal from a communication apparatus other than the communication apparatus and transmit the signal to the processor, or send a signal from the processor to a communication apparatus other than the communication apparatus. The processor is configured to implement, by using a logic circuit or executing code instructions, the method provided in the embodiments.

In some embodiments, a communication apparatus is provided, and includes a processor and a communication interface. The communication interface is configured to: receive a signal from a communication apparatus other than the communication apparatus and transmit the signal to the processor, or send a signal from the processor to a communication apparatus other than the communication apparatus. The processor is configured to implement, by using a logic circuit or executing code instructions, the method provided in the embodiments.

In some embodiments, a computer-readable storage medium is provided. The computer-readable storage medium stores a computer program or instructions, and in response to the computer program or the instructions being executed by a processor, the method provided in the embodiments is implemented.

In some embodiments, a computer program product including instructions is provided. in response to the instructions being run by a processor, the method provided in the embodiments are implemented.

In some embodiments, a chip system is provided. The chip system includes a processor, and further includes a memory, to implement the method provided in the embodiments. The chip system includes a chip, or includes a chip and another discrete component.

In some embodiments, a communication system is provided. The system includes the apparatus (for example, the terminal device) according to the embodiments and the apparatus (for example, the network device) according to the embodiments.

### BRIEF DESCRIPTION OF DRAWINGS

FIG. 1 is a schematic diagram of a 5G core network-based positioning architecture in accordance with some embodiments;

FIG. 2 is a schematic flowchart of a signal transmission method according to some embodiments;

FIG. 3(a) and FIG. 3(b) are schematic diagrams of signal frequency hopping transmission according to some embodiments;

FIG. 4 is a schematic diagram of reference sequence division according to some embodiments;

FIG. 5(a) and FIG. 5(b) are schematic diagrams of signal frequency hopping transmission according to some embodiments;

FIG. 6 is a schematic diagram of signal frequency hopping transmission according to some embodiments;

FIG. 7 is a schematic diagram of signal frequency hopping transmission according to some embodiments;

FIG. 8 is a schematic diagram of converting a signal to frequency domain according to some embodiments;

FIG. 9 is a schematic diagram of a positioning procedure according to some embodiments;

FIG. 10 is a schematic diagram of a structure of a communication apparatus according to some embodiments; and

FIG. 11 is a schematic diagram of a structure of a communication apparatus according to some embodiments.

### DESCRIPTION OF EMBODIMENTS

When an SRS is used for channel measurement, the SRS is transmitted in a frequency hopping manner, to increase a bandwidth of an SRS sent by a terminal device. in response to the SRS being used for positioning, in response to this manner being still used, the terminal device sends SRSs at a plurality of consecutive frequency hopping moments, and a base station superimposes the SRSs at the plurality of consecutive frequency hopping moments, to implement effect of a “large broadband”.

However, in this manner, in response to the SRS being transmitted in a frequency hopping manner, SRSs sent by different terminal devices at a same frequency hopping moment is kept orthogonal, but signals obtained after SRSs sent by different terminal devices at a plurality of consecutive frequency hopping moments are superimposed is unable to be kept orthogonal. Positioning precision is reduced in response to the signals obtained after the SRSs sent by the different terminal devices at the plurality of consecutive frequency hopping moments being superimposed are not orthogonal.

Therefore, some embodiments provide a technical solution for sending and receiving a signal. The technical solution is applied to SRS transmission. Further, the technical solution is applied to positioning performed by using the SRS. The following further describes in detail embodiments with reference to the accompanying drawings.

The technical solutions in embodiments are applied to various communication systems, for example, an NR system and a long term evolution (long term evolution, LTE) system. This is not limited herein.

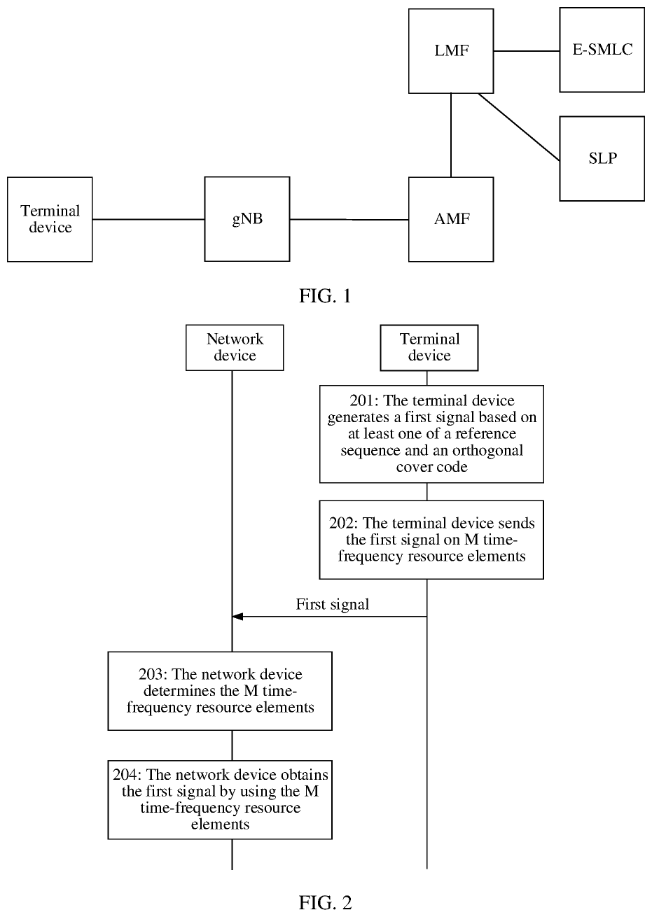

FIG. 1 is a schematic diagram of a 5G core network-based positioning architecture in accordance with some embodiments. In the network shown in FIG. 1, functions of functional entities are as follows:

Terminal device: The terminal device sends a reference signal, for example, a pos-SRS, so that a device such as a next generation NodeB (gNB) on a network side positions the terminal device based on the pos-SRS.

gNB: The gNB measures a reference signal from a terminal device, to obtain measurement information, and transfer the measurement information to a location management function (LMF) network element. The gNB further provides another function, for example, provide a wireless connection for the terminal device.

LMF network element: The LMF network element is responsible for supporting different types of location services related to a target terminal device, including positioning the terminal device and transferring assistance data to the terminal device. A control plane and a user plane of the LMF network element are respectively an enhanced serving mobile location center (E-SMLC) network element and a secure user plane location platform (SLP) network element.

AMF network element: The AMF network element receives a location service request related to a terminal device, or the AMF network element performs a location service, and forward the location service request to an LMF. After obtaining location information returned by the terminal device, the AMF network element returns the related location information to a location service (LCS) entity.

In some embodiments, the terminal device is a device that has a wireless transceiver function or a chip that is disposed in any device, or is referred to as user equipment (UE), an access terminal, a subscriber unit, a subscriber station, a mobile station, a mobile console, a mobile device, a user terminal, a wireless communication device, or a user apparatus. The terminal device in some embodiments are a mobile phone, a tablet computer (Pad), a computer having a wireless transceiver function, a virtual reality (VR) terminal, an augmented reality (AR) terminal, a wireless terminal in industrial control, a wireless terminal in self driving, a wireless terminal in remote medical, a wireless terminal in a smart grid, or the like.

The terminal device is a reduced-capability (REDCAP) terminal device, or is a legacy-capability, normal-capability, or high-capability terminal device, or is referred to as a legacy terminal device or a normal terminal device. The REDCAP terminal device and the legacy terminal device are different in terms of at least a bandwidth capability. For example, a maximum bandwidth supported by the REDCAP terminal device is low, for example, 50 MHz, 40 MHz, 20 MHz, 15 MHz, 10 MHz, or 5 MHz, and a maximum bandwidth supported by the legacy terminal device is high, for example, 100 MHz.

Network device: The network device is a gNB in an NR system, an evolved NodeB (eNB) in an LTE system, or the like. in response to the network device being the gNB, the network device includes a central unit (CU) and a distributed unit (DU).

In some embodiments a network architecture and a service scenario described in some embodiments are intended to describe the technical solutions in some embodiments more clearly, and do not constitute a limitation on the technical solutions provided in some embodiments. A person of ordinary skill in the art is able to know that with evolution of the network architecture and emergence of new service scenarios, the technical solutions provided in some embodiments are also applicable to similar technical problems.

In some embodiments, interaction between the terminal device and the network device is used as an example for description. The method provided in some embodiments are further applied to interaction between other entities, for example, interaction between a chip or a module in the terminal device and a chip or a module in the network device. in response to a chip or a module executing the method, reference is made to the descriptions in some embodiments. Details are not described herein.

With reference to the foregoing descriptions, FIG. 2 is a schematic flowchart of a signal transmission method according to some embodiments. Refer to FIG. 2. The method includes the following steps.

Step 201: A terminal device generates a first signal based on at least one of a reference sequence and an orthogonal cover code.

In some embodiments, the reference sequence is a sequence in a sequence set, and any two sequences in the sequence set are orthogonal to each other. The orthogonal cover code (OCC) is an OCC in an OCC set, and any two OCCs in the OCC set are orthogonal to each other.

Step 202: The terminal device sends the first signal on M time-frequency resource elements.

The first signal includes M sub-signals, and M is an integer greater than 1. The first signal is used for positioning. For example, the first signal is a positioning reference signal, and the positioning reference signal includes but is not limited to a pos-SRS.

The M time-frequency resource elements are in a one-to-one correspondence with the M sub-signals included in the first signal, that is, one of the M time-frequency resource elements is used to carry one of the M sub-signals. In this case, an i^{th} sub-signal in the M sub-signals is carried on an i^{th} time-frequency resource element in the M time-frequency resource elements, where i=1, 2, . . . , and M.

In some embodiments any two of the M time-frequency resource elements do not overlap in frequency domain or in time domain. In other words, the M sub-signals are transmitted on the M time-frequency resource elements in a frequency hopping manner.

In some embodiments, one time-frequency resource element occupies one or more orthogonal frequency division multiplexing (OFDM) symbols in time domain, and occupies one or more physical resource blocks (PRB) in frequency domain

In some embodiments, the M time-frequency resource elements corresponds to M bandwidth units in frequency domain, and one time-frequency resource element corresponds to one bandwidth unit. The bandwidth unit includes at least one subcarrier or include at least one bandwidth part (BWP). Alternatively, the bandwidth unit is a preset fixed bandwidth. For example, the bandwidth unit is a 20 MHz bandwidth.

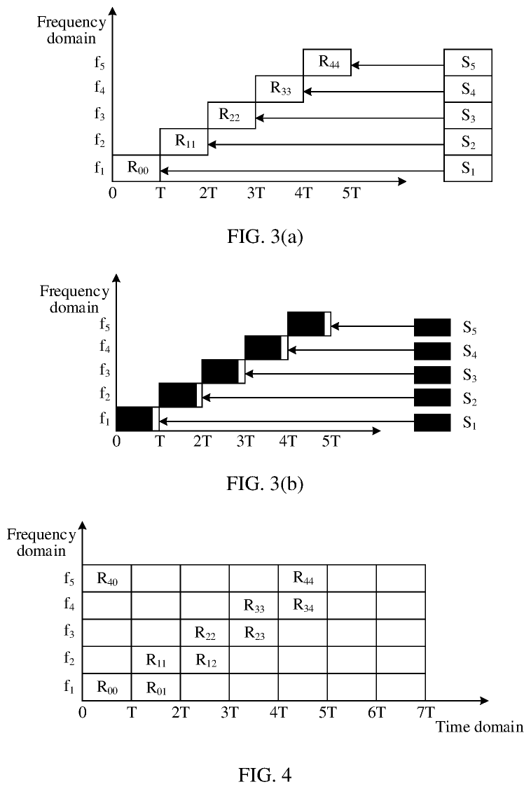

For example, as shown in FIG. 3(a), M=5 is assumed. In this case, five time-frequency resource elements are respectively R₀₀, R₁₁, R₂₂, R₃₃, and R₄₄, a frequency corresponding to an ith time-frequency resource element is fᵢ(i =1,2, . . . , 5), and five sub-signals included in a first signal are respectively S₁ to S₅. S₁ is carried in the time-frequency resource element R₀₀, S₂ is carried in the time-frequency resource element R₁₁, S₃ is carried in the time-frequency resource element R₂₂, S₄ is carried in the time-frequency resource element R₃₃, and S₅ is carried in the time-frequency resource element R₄₄.

In some embodiments, radio frequency retuning further calls for being performed in response to the terminal device performing frequency hopping transmission between different time-frequency resource elements. For example, in response to the terminal device being switched from the time-frequency resource element R₁₁ to the time-frequency resource element R₂₂, a radio frequency transmit channel of the terminal device also calls for being adapted from a frequency of the time-frequency resource element R₁₁ to a frequency of the time-frequency resource element R₂₂. A time is a condition to readjust one frequency adapted to the radio frequency transmit channel of the terminal device to another frequency, and the time is denoted as a radio frequency readjustment time or a radio frequency retuning time. Therefore, last several OFDM symbols in the time-frequency resource element are not used to transmit any signal, and are used to perform radio frequency retuning on the radio frequency transmit channel of the terminal device.

A sub-signal carried in one time-frequency resource element occupies a part in time domain. For example, the time-frequency resource element includes 14 OFDM symbols, the sub-signal occupies 10 consecutive OFDM symbols, some of other OFDM symbols are used to transmit other information, and the other part is used to perform radio frequency retuning.

For example, with reference to FIG. 3(a), as shown in FIG. 3(b), the five sub-signals S₁ to S₅ included in the first signal respectively occupy some time domain resources and some frequency domain resources on corresponding time-frequency resource elements.

In addition, any two of M sub-signals occupies a same quantity of OFDM symbols in time domain, or occupies different quantities of OFDM symbols in time domain.

In some embodiments, there is another signal, for example, a second signal, in a frequency domain resource occupied by the first signal in frequency domain. The first signal is orthogonal to the second signal. A frequency domain resource occupied by the first signal in frequency domain completely or partially overlaps a frequency domain resource occupied by the second signal in frequency domain. In some embodiments, similar to the first signal, the second signal further includes M sub-signals.

The second signal corresponds to a sequence other than a reference sequence in a sequence set, and the second signal corresponds to an OCC other than an OCC in an OCC set.

For example, the second signal is carried on N time-frequency resource elements, and frequency domain resources of the M time-frequency resource elements completely or partially overlap frequency domain resources of the N time-frequency resource elements, where N is an integer greater than 0, and a value of N is equal to a value of M.

For example, in response to N=M=5, as shown in FIG. 4, five sub-signals included in a first signal are transmitted through frequency hopping respectively on time-frequency resource elements R₀₀, R₁₁, R₂₂, R₃₃, and R₄₄, and five sub-signals included in a second signal are transmitted through frequency hopping respectively on time-frequency resource elements R₄₀, R₀₁, R₁₂, R₂₃, and R₃₄. FIG. 4 shows that a frequency domain resource occupied by the first signal in frequency domain completely overlaps a frequency domain resource occupied by the second signal in frequency domain. In some embodiments the first signal and the second signal occupies a same time-frequency resource element. In other words, the five sub-signals included in the second signal is transmitted through frequency hopping respectively on the time-frequency resource elements R₀₀, R₁₁, R₂₂, R₃₃, and R₄₄.

Optionally, in response to a frequency domain resource occupied by the first signal in frequency domain partially overlapping a frequency domain resource occupied by the second signal in frequency domain, a bandwidth of an overlapped frequency domain resource is greater than or equal to a threshold. A value of the threshold is determined based on an actual situation. This is not limited some embodiments.

For example, with reference to FIG. 4, in response to a bandwidth of one time-frequency resource element being 20 MHz, and N=M=4, four sub-signals included in the first signal are transmitted through frequency hopping respectively on the time-frequency resource elements R₀₀, Ru, R₂₂, and R₃₃, and four sub-signals included in the second signal are transmitted through frequency hopping respectively on the time-frequency resource elements R₁₂, R₂₃, R_{34,} and R₄₀. In this case, assuming that the threshold is 40 MHz, the first signal and the second signal calls for being orthogonal; and assuming that the threshold is 80 MHz, the first signal and the second signal is unable to be orthogonal.

In some embodiments the first signal and the second signal is generated and sent by different terminal devices. For clarity, in response to a relationship between the first signal and the second signal being described, a terminal device that generates the first signal is referred to as a first terminal device, and a sub-signal included in the first signal is referred to as a first sub-signal. Correspondingly, a terminal device that generates the second signal is referred to as a second terminal device, and a sub-signal included in the second signal is referred to as a second sub-signal. Optionally, an i^{th} first sub-signal carried in an i^{th} time-frequency resource element is orthogonal to an i^{th} second sub-signal carried in the i^{th} time-frequency resource element. That is, a first sub-signal carried on each time-frequency resource element is orthogonal to a second sub-signal carried on the time-frequency resource element, and a first signal including M first sub-signals carried on the M time-frequency resource elements is also orthogonal to a second signal including M second sub-signals carried on the M time-frequency resource elements.

In addition, in addition to the first signal, frequency domain resources corresponding to the M time-frequency resource elements further carries more signals. In addition to the second signal, the first signal is further orthogonal to other signals carried on frequency domain resources corresponding to the M time-frequency resource elements. For example, any two of the plurality of signals carried on the frequency domain resources corresponding to the M time-frequency resource elements are configured to be orthogonal. The plurality of signals are generated and sent by different terminal devices, and the terminal devices that generate and send the plurality of signals accesses a same network device, that is, the network device simultaneously provides wireless connections for the terminal devices.

Step 203: The network device determines the M time-frequency resource elements.

How the network device determines the M time-frequency resource elements is not limited some embodiments. Details are not described herein.

Step 204: The network device obtains the first signal on the M time-frequency resource elements.

According to the foregoing method, because at least some signals carried on the M time-frequency resource elements are orthogonal to each other, mutual interference between signals sent on the M time-frequency resource elements are reduced. in response to the first signal being used for positioning, positioning precision is improved.

In some embodiments, the first signal is generated in a plurality of manners. Details are described below.

In Some embodiments, the first signal is generated based on a reference sequence. A bandwidth corresponding to a length of the reference sequence is greater than or equal to a sum of bandwidths of M time-frequency resource elements; or a bandwidth corresponding to a length of the reference sequence is greater than or equal to a bandwidth of the first signal.

A manner of generating the reference sequence is not limited in some embodiments. In some embodiments, the reference sequence is generated based on a Zadoff-Chu (ZC) sequence.

In Some embodiments, the terminal device generates M sub-sequences based on the reference sequence, and then respectively generate M sub-signals based on the M sub-sequences, that is, generates one of the M sub-signals based on one of the M sub-sequences. The M sub-sequences are generated together, or is separately generated. For example, the terminal device generates the M sub-sequences in response to or before a first sub-signal in the M sub-signals calls for being sent, and then generate the sub-signals based on the corresponding sub-sequences in response to the sub-signal calling for being sent. Alternatively, the terminal device generates the corresponding sub-sequences based on the reference sequence in response to a sub-signal calling for being sent, to generate the corresponding sub-signals. Alternatively, the terminal device directly generates the M sub-signals based on the reference sequence, and some reference sequences used in a process of generating a single sub-signal are considered as sub-sequences.

In some embodiments the sequence is a bit sequence of a length. The terminal device performs operations such as coding and modulation on the sequence, to obtain a corresponding signal.

With reference to the foregoing description, in Some embodiments, the first signal is generated in at least two implementations.

In some embodiments, the reference sequence is a sequence in a sequence set, the sequence set includes one of a plurality of sequences, and any two of the plurality of sequences are orthogonal to each other. The terminal device selects one sequence from the plurality of sequences as the reference sequence. How the terminal device determines the reference sequence from the plurality of sequences is not limited in some embodiments. For example, the reference sequence is indicated by the network device to the terminal device by using signaling. In same M time-frequency resource elements, the network device configures mutually orthogonal reference sequences for different terminal devices.

In some embodiments the sequence set is configured by the network device, or is determined in another manner. This is not limited in some embodiments.

In some embodiments, an i^{th} sub-signal in the M sub-signals included in the first signal is generated based on an i^{th} sub-sequence in the M sub-sequences, where i=1, 2, . . . , and M. Any one of the M sub-sequences is a part of the reference sequence, that is, any one of the M sub-sequences are intercepted from the reference sequence.

Optionally, any two of the M sub-sequences are non-overlapping sequences intercepted from the reference sequence.

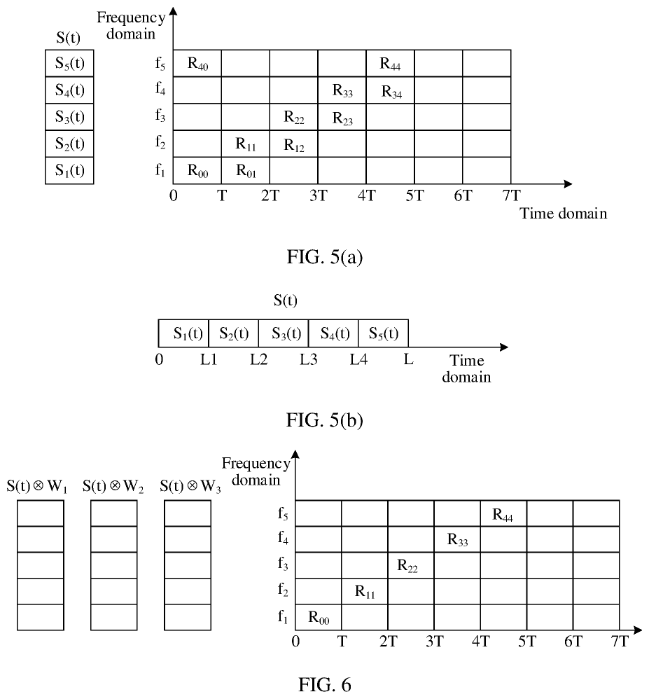

For example, M=5. As shown in FIG. 5(a), a bandwidth corresponding to a length of a reference sequence S(t) is 100 MHz is assumed, five non-overlapping sub-sequences are intercepted from the reference sequence, a bandwidth corresponding to a length of each sub-sequence is 20 MHz, and the five sub-sequences are respectively S₁(t) to S₅(t). From a perspective of frequency domain, bandwidths corresponding to lengths of the five sub-sequences are equal to the bandwidth corresponding to the length of the reference sequence S(t). As shown in FIG. 5(b), from a perspective of time domain, the sub-sequence S₁(t) is a sequence whose length is 0 to L₁ in the reference sequence, the sub-sequence S₂(t) is a sequence whose length is L₁+1 to L₂ in the reference sequence, the sub-sequence S₃(t) is a sequence whose length is L₂+1 to L₃ in the reference sequence, the sub-sequence S₄(t) is a sequence whose length is L₃+1 to L₄ in the reference sequence, and the sub-sequence Ss(t) is a sequence whose length is L₄+1 to L in the reference sequence.

The terminal device sends, in a corresponding time-frequency resource element, a sub-signal corresponding to the sub-sequence S₁(t). In FIG. 5(a), five sub-signals corresponding to the sub-sequences S₁(t) to S₅(t) is sequentially transmitted through frequency hopping on time-frequency resource elements R₀₀, Ru, R₂₂, R₃₃, and R₄₄. In some embodiments, a sub-signal corresponding to an i^{th} (i=1, 2, . . . , and 5) sub-sequence is carried on an i^{th} time-frequency resource element in the M time-frequency resource elements is assumed, and a bandwidth Wᵢ corresponding to a length of the i^{th} sub-sequence is less than or equal to a bandwidth of the i^{th} time-frequency resource element.

It is assumed that a first signal sent by a terminal device 1 includes five sub-signals corresponding to sub-sequences S₁(t) to S₅(t), and a second signal sent by a terminal device 2 includes five sub-signals corresponding to sub-sequences S₁(t)′ to S₅(t)′. The five sub-signals corresponding to the sub-sequences S₁(t)′ to S₅(t)′ is transmitted through frequency hopping on time-frequency resource elements R₀₀, R₁₁, R₂₂, R₃₃, and R₄₄, or is transmitted through frequency hopping on time-frequency resource elements R₄₀, R₀₁, R₁₂, R₂₃, and R₃₄.

When the five sub-signals corresponding to the sub-sequences S₁(t)′ to S₅(t)′ are transmitted through frequency hopping by using the time-frequency resource elements R₀₀, R₁₁, R₂₂, R₃₃, and R₄₄, although the first signal and the second signal occupy a same frequency domain resource, because the first signal and the second signal are orthogonal to each other, the network device further distinguishes between the first signal and the second signal. Correspondingly, in response to the five sub-signals corresponding to the sub-sequences S₁(t)′ to S₅(t)′ being transmitted through frequency hopping by using the time-frequency resource elements R₄₀, R₀₁, R₁₂, R₂₃, and R₃₄, although the first signal and the second signal also occupy a same frequency domain resource, because the first signal and the second signal are orthogonal to each other, the network device further distinguishes between the first signal and the second signal.

In some embodiments, the reference sequence calls for being selected from a plurality of orthogonal sequences. in response to a generation manner of the second signal being the same as a generation manner of the first signal, a reference sequence used to generate the first signal calls for being orthogonal to a reference sequence used to generate the second signal, so that the first signal and the second signal are orthogonal. Different terminal devices are configured to select different orthogonal sequences, so that signals sent by the terminal devices on a plurality of same time-frequency resource elements are orthogonal to each other.

In some embodiments, the M sub-signals included in the first signal is generated based on a reference sequence and an OCC. The M sub-signals are generated by extending the reference sequence by using the OCC, where an i^{th} sub-signal in the M sub-signals is generated by extending, by using the OCC, an i^{th} sub-sequence obtained by intercepting the reference sequence.

For example, three terminal devices is assumed, that is, a terminal device 1, a terminal device 2, and a terminal device 3, use a same reference sequence S(t). For example, M=5. The reference sequence S(t) includes five sub-sequences, that is, S(t)=[X₁(t) X₂(t) X₃(t) X₄(t) X₅(t)].

It is assumed that an OCC selected by a terminal device 1 is W₁, an OCC selected by a terminal device 2 is W₂, and an OCC selected by a terminal device 3 is W₃. The OCCs respectively meet the following forms:

W₁=[a₁(t) g₁(t) h₁(t) p₁(t) k₁(t)];

W₂=[a₂(t) g₂(t) h₂(t) p₂(t) k₂(t)]; and

W₃=[a₃(t) g₃(t) h₃(t) p₃(t) k₃(t)].

Herein, W₁, W₂, and W₃ are orthogonal to each other.

For example, W₁, W₂, and W₃ is shown in Table 1.

TABLE 1

| | OCC |
|---|---|
| W₁ | $[ \frac{j}{\sqrt{2}} , \frac{j}{\sqrt{2}} , 1 , 1 , 1 ]$ |
| W₂ | $[ \frac{j}{\sqrt{2}} , \frac{j}{\sqrt{2}} , 1 , 1 , - 1 ]$ |
| W₃ | $[ \frac{- j}{\sqrt{2}} , \frac{- j}{\sqrt{2}} , 1 , - 1 , - 1 ]$ |

In Table 1, each OCC includes five elements. W₁ is used as an example. In

$${W}_{1} , {a}_{1} ( t ) = \frac{j}{\sqrt{2}} ; {g}_{1} ( t ) = \frac{j}{\sqrt{2}} ;$$

h₁(t)=1; p₁(t)=1; k₁(t)=1; and j²=−1. Another case is not described again. Table 1 is an example. There is other OCCs. Details are not described herein again.

With reference to the foregoing example, a sub-sequence corresponding to an i^{th} sub-signal in the M sub-signals included in the first signal generated by the terminal device 1 is Sᵢ(t)=Xᵢ(t)⊗W₁ (m), where W₁ (m) is an m^{th} element in W₁ . For example, Sᵢ(t)=Xᵢ(t)⊗a₁(t), Sᵢ(t)=Xᵢ(t)⊗g₁(t), Sᵢ(t)=Xᵢ(t)⊗h₁(t), Sᵢ(t)=Xᵢ(t)⊗p₁(t), or Sᵢ(t)=Xᵢ(t)⊗k1(t). For another case, refer to the descriptions herein. Details are not described again.

The terminal device 1, the terminal device 2, and the terminal device 3 sends, on corresponding time-frequency resource elements, the first signals generated by the terminal device 1, the terminal device 2, and the terminal device 3. In FIG. 6, five sub-signals included in a first signal generated by each of the terminal device 1, the terminal device 2, and the terminal device 3 is sequentially transmitted through frequency hopping on time-frequency resource elements R₀₀, R₁₁, R₂₂, R₃₃, and R₄₄.

Optionally, in FIG. 6, different terminal devices further sends the first signal on different time-frequency resource elements. For example, the five sub-signals included in the first signal generated by the terminal device 1 is transmitted through frequency hopping on time-frequency resource elements R₀₀, R₁₁, R₂₂, R₃₃, and R₄₄, and the five sub-signals included in the first signal generated by the terminal device 2 is transmitted through frequency hopping on time-frequency resource elements R₄₀, R₀₁, R₁₂, R₂₃, and R₃₄.

In some embodiments, in this implementation, the reference sequence is a sequence selected from a sequence set, or is obtained in another manner. Reference sequences selected by different terminal devices are or are unable to be orthogonal to each other. This is not limited in some embodiments. How the terminal device determines an OCC from a plurality of OCCs is not limited in some embodiments. For example, the network device indicates the OCC by using signaling. In the M same time-frequency resource elements, the network device configures different OCCs for different terminal devices.

In some embodiments, in response to a generation manner of a second signal being the same as a generation manner of the first signal, a reference sequence used to generate the first signal and a reference sequence used to generate the second signal is unable to be orthogonal to each other. For example, the reference sequence used to generate the first signal is the same as the reference sequence used to generate the second signal. In this case, an OCC used to generate the first signal and an OCC used to generate the second signal calls for being orthogonal to each other, so that the first signal and the second signal are orthogonal. Different terminal devices are configured to select different OCCs, so that signals sent by the terminal devices on a plurality of same time-frequency resource elements are orthogonal to each other.

In the foregoing embodiment, a length of the reference sequence used to generate the first signal corresponds to a high bandwidth. In some embodiments, the first signal is generated based on a reference sequence whose length corresponds to a low bandwidth. For details, refer to descriptions in Embodiment 2.

In some embodiments, the M sub-signals included in the first signal is generated based on a reference sequence and an OCC. The OCC includes M elements, and the M elements are in a one-to-one correspondence with the M sub-signals. A bandwidth corresponding to a length of the reference sequence is less than or equal to a bandwidth of a time-frequency resource element; or a bandwidth corresponding to a length of the reference sequence is less than or equal to a bandwidth of any one of the M sub-signals.

In some embodiments different terminal devices are configured to use reference sequences that are not mutually orthogonal. For example, two different terminal devices are configured to use a same reference sequence.

In some embodiments, the M sub-signals correspond to a same reference sequence. A sub-sequence corresponding to each of the M sub-signals is generated by extending the reference sequence by using the OCC.

For example, a bandwidth corresponding to the length of the reference sequence is 20 MHz, and a bandwidth corresponding to each sub-signal is 20 MHz. For example, M=5. For a reference sequence S(t), a sub-sequence S,(t) corresponding to a sub-signal sent in an i^{th} time-frequency resource element is a sequence generated by extending the reference sequence by using an OCC Wᵢ, where Sᵢ(t)=S(t)⊗W₁(m), and W₁(m) is an m^{th} element in W₁ .

It is assumed that two terminal devices, that is, a terminal device 1and a terminal device 2, both use a same reference sequence S(t). An OCC selected by the terminal device 1 is W₁ is assumed, and an OCC selected by the terminal device 2 is W₂. The OCCs respectively meet the following forms:

W₁=[a₁(t) g₁(t) h₁(t) p₁(t) k₁(t)]; and

W₂=[a₂(t) g₂(t) h₂(t) p₂(t) k₂(t)].

Herein, W₁ and W₂ are orthogonal to each other.

The terminal device 1 is used as an example. A sub-sequence corresponding to an ith sub-signal in the M sub-signals included in the first signal generated by the terminal device 1 is Sᵢ(t)=S(t)⊗W₁(m), where W₁(m) is an m^{th} element in W₁ . For example, Sᵢ(t)=S(t)⊗a₁(t), Sᵢ(t)=S(t)⊗g₁(t), Sᵢ(t)=S(t)⊗hᵢ(t), Sᵢ(t)=S(t)⊗p₁(t), or Sᵢ(t)=S(t)⊗k₁(t). A sub-sequence corresponding to an i^{th} sub-signal in the M sub-signals included in the first signal generated by the terminal device 2 is Sᵢ(t)=S(t)⊗W₂(m), where W₂(m) is an m^{th} element in W₂. For example, Sᵢ(t)=S(t)⊗a₂(t), Sᵢ(t)=S(t)⊗g₂(t), Sᵢ(t)=S(t)⊗h₂(t), S₁(t)=S(t)⊗p₂(t), or S₁(t)=S(t)⊗k₂(t).

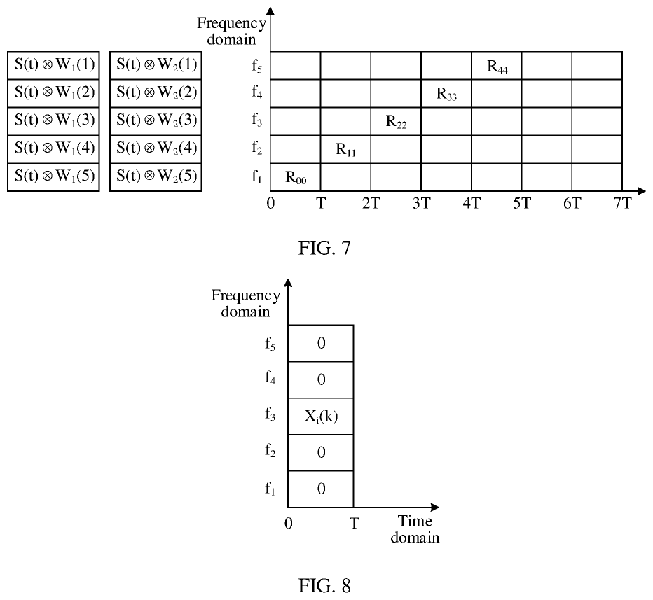

The terminal device 1 and the terminal device 2 sends, on corresponding time-frequency resource elements, the first signals generated by the terminal device 1 and the terminal device 2. In FIG. 7, five sub-signals included in a first signal generated by each of the terminal device 1 and the terminal device 2 is sequentially transmitted through frequency hopping on time-frequency resource elements R₀₀, R₁₁, R₂₂, R₃₃, and R₄₄.

In this embodiment, the OCC ensures that the first signals generated by the different terminal devices are orthogonal to each other, and ensures that a receiving end restores signals from the different terminal devices.

With reference to the foregoing descriptions in Some embodiments and Some embodiments, in response to receiving the M sub-signals in the M time-frequency resource elements, the network device combines the M sub-signals distributed in different frequency ranges into one signal, that is, the first signal. In this case, the first signal is considered as a sum of M sub-signals in a plurality of different frequency ranges in frequency domain, and a bandwidth of the first signal is a sum of bandwidths of the M sub-signals. Because the bandwidth of the first signal is high, in response to the location information of the terminal device being determined based on the first signal, the location information of the terminal device is accurately determined. Details are described below. In the following description, an example in which a bandwidth of each time-frequency resource element is 20 MHz, and M=5, that is, the bandwidth of the first signal is 100 MHz is used for description. Other cases are deduced by analogy. Details are not described again.

It is assumed that after an i^{th} sub-signal sent by the terminal device in an i^{th} time-frequency resource element is sampled in time domain, a time domain expression of an nth (n=1, . . . , and a maximum quantity of symbols) sampling sample is as follows:

$${s}_{i} ( n ) = \frac{1}{N} {\sum }_{k = 0}^{N - 1} {X}_{i} ( k ) {e}^{j 2 π k \frac{n}{N}}$$

Herein, N is a fast Fourier transform (FFT) size corresponding to a narrowband. Assuming that a bandwidth of a time-frequency resource element is 20 MHz, N=1024. Xᵢ(k) is discrete Fourier transform (DFT) of sᵢ(n); and Δf is a subcarrier spacing.

With reference to the foregoing description, in response to receiving the sub-signal sᵢ(n) in the i^{th} time-frequency resource element, the network device transforms sᵢ(n) to a frequency domain, to obtain Xᵢ(k).

The network device combines the M sub-signals into one high-bandwidth signal, that is, the first signal, so that the location information of the terminal device is accurately determined based on the first signal. Details are described below.

The network device adds zeros to Xᵢ(k) in frequency domain, that is, extends Xᵢ(k) to a broadband sequence (100 MHz). For example, in a sequence received from an i^{th} time-frequency resource element (whose frequency is fᵢ), an fᵢ frequency domain part is reserved, and zeros are padded in other frequency domains. A schematic diagram of a frequency domain is shown in FIG. 8.

$${\tilde{X}}_{i} ( k ) = \{ \begin{matrix}{X}_{i} ( k ) , i \times ( N - 1 ) \leq k < i \times N \\ 0 , others\end{matrix}$$

Then, the network device transforms Xᵢ(k) to a time domain, to obtain the following:

$${\tilde{s}}_{i} ( n ) = \frac{1}{\tilde{N}} {\sum }_{k = 0}^{\tilde{N} - 1} {\tilde{X}}_{i} ( k ) {e}^{j 2 π k \frac{n}{\tilde{N}}}$$

Herein, Ñ is an FFT size corresponding to a broadband, for example, an FFT size corresponding to 100 MHz, that is, Ñ=4096; sᵢ(n) and \tilde{s}ᵢ(n) respectively correspond to time domain signals (n^{th} samples) on a narrowband (20 MHz) and a large broadband (100 MHz); and Xᵢ(k) and \tilde{X}ᵢ(k) respectively correspond to frequency domain signals on a narrowband and a large broadband.

In some embodiments the network device calls for having a signal processing capability of 100 MHz and support a sampling rate of 100 MHz, to perform the foregoing process.

The network device superimposes, in time domain, five sub-signals received in five consecutive time-frequency resource elements, to restore a high-bandwidth signal (100 MHz). A frequency band of the high-bandwidth signal carries sequence information on five frequency sub-bands (fᵢ=20 MHz, i=1,2, . . . ,5). For details about a signal obtained after the five sub-signals are superimposed, refer to the following formula.

$${\sum }_{i = 1}^{5} {\tilde{s}}_{i} ( n ) = \frac{1}{\tilde{N}} {\sum }_{i = 1}^{5} {\sum }_{k = 1}^{\tilde{N} - 1} \tilde{{X}_{i}} ( k ) {e}^{j 2 π k \frac{n}{\tilde{N}}}$$

The network device performs related measurement by using the restored high-bandwidth signal for positioning. How to perform measurement and positioning is not limited in some embodiments. For details, refer to descriptions in the existing document. The details are not described herein.

According to the method provided in some embodiments, high-bandwidth signals obtained after low-bandwidth signals sent by different terminal devices in a plurality of consecutive time-frequency resource elements are superimposed are still orthogonal to each other is ensured, so that the receiving end successfully restores a large-broadband signal for positioning, to improve positioning precision.

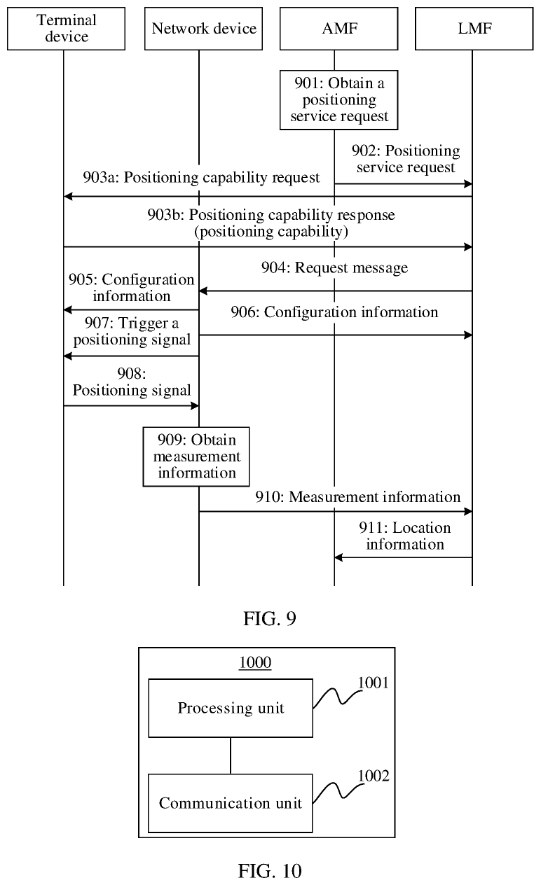

FIG. 9 is a schematic diagram of a positioning procedure in accordance with some embodiments. FIG. 9 lists some steps in the positioning procedure. Detailed steps in the positioning procedure vary with different positioning scenarios and methods, and are not listed one by one herein.

Step 901: An AMF network element obtains a positioning service request, where the positioning service request is used to obtain information such as a positioning location of a terminal device.

The positioning service request is sent by an LCS entity, or is sent by the terminal device. This is not limited in some embodiments.

Step 902: The AMF network element forwards the positioning service request to an LMF network element.

Step 903a: The LMF network element sends a positioning capability request message to the terminal device, where the positioning capability request message is used to request a positioning capability of the terminal device.

For example, the positioning capability request message is sent by using an LTE positioning protocol (LPP) message.

Step 903b: The terminal device sends a positioning capability response message to the LMF network element, where the positioning capability response message includes the positioning capability of the terminal device.

The positioning capability refers to a positioning technology supported by the terminal device, for example, a capability of supporting global navigation satellite system (GNSS)-based positioning, a capability of supporting an observed time difference of arrival (OTDOA)-based positioning technology, and a capability of supporting sensor-based positioning.

Step 904: The LMF network element sends a request message to a network device, to request related information of a positioning signal, for example, configuration information of the positioning signal.

The positioning signal is a signal sent by the terminal device on the M time-frequency resource elements in the foregoing embodiment, for example, a first signal. The first signal further is a pos-SRS.

Step 905: The network device sends the configuration information of the positioning signal to the terminal device.

The configuration information indicates one or more of the following:

locations, a quantity N, and the like of time-frequency resource elements occupied by the positioning signal;

a quantity of frequency hopping times in the N time-frequency resource elements, for example, the quantity of frequency hopping times are equal to N;

a comb size;

a quantity that is of (code domain) orthogonalization dimensions and that is achieved through cyclic shift; and

a reference sequence, or a parameter for generating a reference sequence.

The configuration information further includes other content. Details are not described herein.

Step 906: The network device sends the configuration information of the positioning signal to the LMF network element.

Optionally, step 907 is performed, that is, the network device triggers the terminal device to send the positioning signal.

Step 908: The terminal device sends the positioning signal.

The positioning signal is the first signal described above. For details, refer to the descriptions in step 201 and step 202.

Step 909: The network device receives the positioning signal, and measures the positioning signal to obtain measurement information.

The measurement information includes but is not limited to a reference signal time difference (RSTD), a round trip time (RTT), reference signal received power (RSRP), reference signal received quality (RSRQ), and the like.

Step 910: The network device sends the measurement information to the LMF network element.

Step 911: The LMF network element performs location calculation based on the measurement information, to obtain location information, and sends the location information to the AMF network element.

How the LMF network element determines the location information based on the measurement information is not limited in some embodiments.

The LMF network element further sends the location information to the terminal device, the network device, or the like.

The foregoing descriptions are an example. The positioning procedure further includes another step. Details are not described herein.

In the foregoing embodiments provided some embodiments, the methods provided in some embodiments are separately described from a perspective of interaction between devices. To implement functions in the method provided in the foregoing some embodiments, the network device or the terminal device includes a hardware structure and/or a software module, and implements the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

In some embodiments, division into the modules is an example and is logical function division, and is other division in an actual implementation. In addition, functional modules in some embodiments are integrated into one processor, or exists alone physically, or two or more modules are integrated into one module. The integrated module is implemented in a form of hardware, or is implemented in a form of a software functional module.

Same as the foregoing concept, as shown in FIG. 10, some embodiments further provides an apparatus 1000, configured to implement functions of network device or the terminal device in the foregoing methods. For example, the apparatus is a software module or a chip system. In some embodiments, the chip system includes a chip, or includes a chip and another discrete component. The apparatus 1000 includes a processing unit 1001 and a communication unit 1002.

In some embodiments, the communication unit further is referred to as a transceiver unit, and includes a sending unit and/or a receiving unit, which are respectively configured to perform sending and receiving steps of the network device or the terminal device in the foregoing method embodiments.

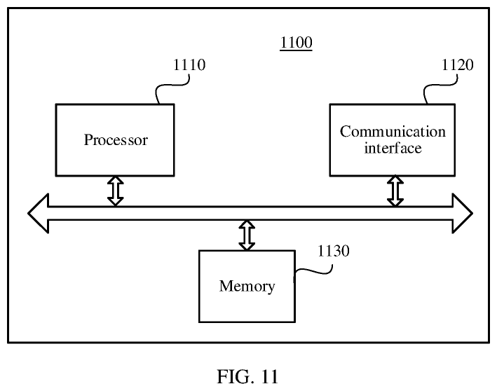

The following describes, in detail with reference to FIG. 10 and FIG. 11, communication apparatuses provided in some embodiments. Descriptions of apparatus embodiments correspond to the descriptions of the method embodiments. Therefore, for content that is not described in detail, refer to the foregoing method embodiments. For brevity, details are not described herein again.

The communication unit further is referred to as a transceiver, a transceiver machine, a transceiver apparatus, or the like. The processing unit further is referred to as a processor, a processing board, a processing module, a processing apparatus, or the like. Optionally, a component that is in the communication unit 1002 and that is configured to implement the receiving function is considered as a receiving unit, and a component that is in the communication unit 1002 and that is configured to implement the sending function is considered as a sending unit.

That is, the communication unit 1002 includes the receiving unit and the sending unit. The communication unit sometimes further is referred to as a transceiver machine, a transceiver, a transceiver circuit, or the like. The receiving unit sometimes further is referred to as a receiver, a receiver machine, a receiver circuit, or the like. The sending unit sometimes further is referred to as a transmitter, a transmitter machine, a transmitter circuit, or the like.

When the communication apparatus 1000 performs the function of the terminal device in the procedure shown in FIG. 2 in the foregoing embodiment,

the processing unit is configured to generate a first signal based on a reference sequence and/or an orthogonal cover code OCC; and

the communication unit is configured to send the first signal on M time-frequency resource elements, where

the first signal includes M sub-signals, the M time-frequency resource elements are in a one-to-one correspondence with the M sub-signals, any two of the M time-frequency resource elements do not overlap in frequency domain or in time domain, and M is an integer greater than 1; and

the reference sequence is a sequence in a sequence set, and any two sequences in the sequence set are orthogonal to each other; and/or the OCC is an OCC in an OCC set, and any two OCCs in the OCC set are orthogonal to each other.

When the communication apparatus 1000 performs the function of the network device the procedure shown in FIG. 2 in the foregoing embodiment,

the processing unit is configured to determine M time-frequency resource elements; and

the communication unit is configured to obtain a first signal on the M time-frequency resource elements, where

the first signal is generated based on a reference sequence and/or an orthogonal cover code OCC, the first signal includes M sub-signals, the M time-frequency resource elements are in a one-to-one correspondence with the M sub-signals, any two of the M time-frequency resource elements do not overlap in frequency domain or in time domain, and M is an integer greater than 1; and

the reference sequence is a sequence in a sequence set, and any two sequences in the sequence set are orthogonal to each other; and/or the OCC is an OCC in an OCC set, and any two OCCs in the OCC set are orthogonal to each other.

The foregoing descriptions are an example. The processing unit 1001 and the communication unit 1002 further performs other functions. For more detailed descriptions, refer to related descriptions in the method embodiments shown in FIG. 2 to FIG. 9. Details are not described herein again.

FIG. 11 shows an apparatus 1100 according to some embodiments. The apparatus shown in FIG. 11 is an implementation of a hardware circuit of the apparatus shown in FIG. 10. The communication apparatus is applicable to the flowchart shown above, and performs functions of the terminal device or the network device in the foregoing method embodiments. For ease of description, FIG. 11 shows main components of the communication apparatus.

As shown in FIG. 11, the communication apparatus 1100 includes a processor 1110 and a communication interface 1120. The processor 1110 and the communication interface 1120 are coupled to each other. In some embodiments the communication interface 1120 is a transceiver or an input/output interface. Optionally, the communication apparatus 1100 further includes a memory 1130, configured to store instructions executed by the processor 1110, or input data for the processor 1110 to run the instructions, or data generated after the processor 1110 runs the instructions.

When the communication apparatus 1100 is configured to implement the methods shown in FIG. 2 to FIG. 6, the processor 1110 is configured to implement a function of the processing unit 801, and the communication interface 1120 is configured to implement a function of the communication unit 802.

When the communication apparatus is a chip applied to a terminal device, the chip in the terminal device implements functions of the terminal device in the foregoing method embodiments. The chip in the terminal device receives information from another module (for example, a radio frequency module or an antenna) in the terminal device, where the information is sent by a network device to the terminal device. Alternatively, the chip in the terminal device sends information to another module (for example, a radio frequency module or an antenna) in the terminal device, where the information is sent by the terminal device to a network device.

When the communication apparatus is a chip applied to a network device, the chip in the network device implements functions of the network device in the foregoing method embodiments. The chip in the network device receives information from another module (for example, a radio frequency module or an antenna) in the network device, where the information is sent by a terminal device to the network device. Alternatively, the chip in the network device sends information to another module (for example, a radio frequency module or an antenna) in the network device, where the information is sent by the network device to a terminal device.

In some embodiments the processor in some embodiments are a central processing unit (CPU), or is another general-purpose processor, a digital signal processor (DSP), an application-specific integrated circuit (ASIC), a field programmable gate array (FPGA), another programmable logic device, a transistor logic device, a hardware component, or any combination thereof. The general-purpose processor is a microprocessor, any conventional processor, or the like.

In some embodiments, the processor is a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or a storage medium in any other form well-known in the art. For example, a storage medium is coupled to a processor, so that the processor reads information from the storage medium and write information into the storage medium. Certainly, the storage medium is a component of the processor. The processor and the storage medium is located in an ASIC. In addition, the ASIC is located in a network device or a terminal device. Certainly, the processor and the storage medium exists in the network device or the terminal device as discrete components.

A person skilled in the art is able to understand that some embodiments are provided as a method, a system, or a computer program product. Therefore, the embodiments are configured to use a form of a hardware embodiment, a software embodiment, or an embodiment with a combination of software and hardware. In addition, the embodiments are configured to use a form of a computer program product that is implemented on one or more computer-usable storage media (including but not limited to a disk memory, an optical memory, and the like) that include computer-usable program code.

Some embodiments are described with reference to the flowcharts and/or the block diagrams of the method, the device (system), and the computer program product according to some embodiments. In some embodiments computer program instructions are used to implement each procedure and/or each block in the flowcharts and/or the block diagrams and a combination of a procedure and/or a block in the flowcharts and/or the block diagrams. These computer program instructions are provided for a general-purpose computer, a dedicated computer, an embedded processor, or a processor of another programmable data processing device to generate a machine, so that the instructions executed by a computer or a processor of another programmable data processing device generate an apparatus for implementing a specified function in one or more procedures in the flowcharts and/or in one or more blocks in the block diagrams.

The computer program instructions alternatively is stored in a computer-readable memory that guides a computer or another programmable data processing device to work in a manner, so that the instructions stored in the computer-readable memory generate an artifact that includes an instruction apparatus. The instruction apparatus implements a specified function in one or more procedures in the flowcharts and/or in one or more blocks in the block diagrams.

A person skilled in the art is able to make various modifications and variations to the embodiments without departing from the scope of the embodiments. In this way, the embodiments are intended to cover these modifications and variations of the embodiments provided that these modifications and variations fall within the scope of the claims and equivalent technologies.

1. A signal sending method, comprising:
generating a first signal based on a reference sequence or an orthogonal cover code (OCC), wherein:
the reference sequence is a sequence in a sequence set; and
any two sequences in the sequence set are orthogonal to each other; or
the OCC is included in an OCC set; and
any two OCCs in the OCC set are orthogonal to each other; and
sending the first signal on M time-frequency resource elements, wherein:
the first signal includes M sub-signals;
the M time-frequency resource elements are in a one-to-one correspondence with the M sub-signals;
any two of the M time-frequency resource elements do not overlap in frequency domain or in time domain; and
M is an integer greater than 1.

2. The method according to claim 1, wherein the generating the first signal based on the reference sequence comprises:
generating the M sub-signals based on the reference sequence, wherein:
the reference sequence includes M sub-sequences, and the M sub-signals are in a one-to-one correspondence with the M sub-sequences.

3. The method according to claim 2, further comprising:
intercepting each of the M sub-sequences from the reference sequence.

4. The method according to claim 1, wherein the generating the first signal based on the reference sequence comprises:
generating the first signal based on the reference sequence and the OCC; and
generating the M sub-signals based on the reference sequence and the OCC, wherein:
the OCC includes the M time-frequency resource elements in the one-to-one correspondence with the M sub-signals.

5. The method according to claim 4, wherein each of the M sub-signals corresponds to the reference sequence.

6. A signal receiving method, comprising:
determining M time-frequency resource elements; and
obtaining a first signal on the M time-frequency resource elements, wherein:
the first signal is generated based on a reference sequence or an orthogonal cover code OCC;
the first signal includes M sub-signals;
the M time-frequency resource elements are in a one-to-one correspondence with the M sub-signals;
any two of the M time-frequency resource elements do not overlap in frequency domain or in time domain;
and M is an integer greater than 1;
the reference sequence is included in a sequence set; and
any two sequences in the sequence set are orthogonal to each other; or
the OCC is included in an OCC set; and
any two OCCs in the OCC set are orthogonal to each other.

7. The method according to claim 6, wherein:
the M sub-signals in the first signal are generated based on the reference sequence that includes M sub-sequences in a one-to-one correspondence with the M sub-signals.

8. The method according to claim 7, wherein each of the M sub-sequences is intercepted from the reference sequence.

9. The method according to claim 6, wherein:
the M sub-signals in the first signal are generated based on the reference sequence and the OCC includes the M time-frequency resource elements in the one-to-one correspondence with the M sub-signals.

10. The method according to claim 9, wherein each of the M sub-signals corresponds to the reference sequence.

11. A communication apparatus, comprises:
a non-transitory memory storage that includes instructions; and
one or more processors in communication with the non-transitory memory storage, wherein the instructions, in response to being executed by the one or more processors, cause the communication apparatus to:
generate a first signal based on a reference sequence or an orthogonal cover code OCC wherein:
the reference sequence is included in a sequence set; and
any two sequences in the sequence set are orthogonal to each other; or
the OCC is included in an OCC set and
any two OCCs in the OCC set are orthogonal to each other; and
send the first signal on M time-frequency resource elements, wherein:
the first signal includes M sub-signals;
the M time-frequency resource elements are in a one-to-one correspondence with the M sub-signals;
any two of the M time-frequency resource elements do not overlap in frequency domain or in time domain; and
M is an integer greater than 1.

12. The apparatus according to claim 11, wherein the instructions, in response to being executed by the one or more processors, further cause the communication apparatus to:
generate the M sub-signals based on the reference sequence, wherein:
the reference sequence includes M sub-sequences in a one-to-one correspondence with the M sub-signals.

13. The apparatus according to claim 12, wherein the instructions, in response to being executed by the one or more processors, further cause the communication apparatus to:
intercept each of the M sub-sequences from the reference sequence.

14. The apparatus according to claim 11, wherein the instructions, in response to being executed by the one or more processors, further cause the communication apparatus to:
generate the M sub-signals based on the reference sequence and the OCC, wherein:
the OCC includes the M time-frequency resource elements in the one-to-one correspondence with the M sub-signals.

15. The apparatus according to claim 14, wherein each of the M sub-signals corresponds to the reference sequence.

16. A communication apparatus, comprises:
a non-transitory memory storage that includes instructions; and
one or more processors in communication with the non-transitory memory storage, wherein the instructions, in response to being executed by the one or more processors, cause the communication apparatus to:
determine M time-frequency resource elements; and
obtain a first signal on the M time-frequency resource elements, wherein:
the first signal is generated based on a reference sequence or an orthogonal cover code OCC;
the first signal includes M sub-signals;
the M time-frequency resource elements are in a one-to-one correspondence with the M sub-signals;
any two of the M time-frequency resource elements do not overlap in frequency domain or in time domain;
M is an integer greater than 1;
the reference sequence is included in a sequence set; and any two sequences in the sequence set are orthogonal to each other; or
the OCC is included in an OCC set; and
any two OCCs in the OCC set are orthogonal to each other.

17. The apparatus according to claim 16, wherein:
the M sub-signals in the first signal are generated based on the reference sequence that includes M sub-sequences in a one-to-one correspondence with the M sub-signals.

18. The apparatus according to claim 17, wherein each of the M sub-sequences is intercepted from the reference sequence.

19. The apparatus according to claim 16, wherein:
the M sub-signals in the first signal are generated based on the reference sequence and the OCC that includes the M time-frequency resource elements in the one-to-one correspondence with the M sub-signals.

20. The apparatus according to claim 19, wherein each of the M sub-signals corresponds to the reference sequence.
